(19) United States
(12) Patent Application Publication
(10) Pub. No.: US 2006/0088739 A1
(43) Pub. Date: Apr. 27, 2006

(54) Power generation and supply system

(75) Inventor: Stanford R. Ovshinsky, Bloomfield Hills, MI (US)

Correspondence Address: ENERGY CONVERSION DEVICES, INC., 2956 WATERVIEW DRIVE, ROCHESTER HILLS, MI, 48309, US

(73) Assignee: Energy Conversion Devices, Inc.

(21) Appl. No.: 10/973,357

(22) Filed: Oct. 26, 2004

(51) Int. Cl. H01M 12/00

(52) U.S. Cl. 429/9

(57) ABSTRACT

A power generation and supply system utilizing one or more solar cells to produce electricity and hydrogen. The power generation and supply system includes an electrolyzer powered by the one or more solar cells for producing hydrogen, a hydrogen distribution system for distributing the hydrogen produced by the electrolyzer, a rechargeable battery for storing electricity produced by the solar cells, and an electricity distribution. The power generation and supply system according may further comprise a hydrogen fueled fuel cell which receives hydrogen produced by the electrolyzer and produces electricity as needed to recharge the rechargeable battery and/or power one or more electrical devices.

### FIELD OF THE INVENTION

The present invention generally relates to a power generation and supply system utilizing a non-fossil fuel source of energy. More particularly, the present invention relates to a power supply and generation system utilizing solar energy to generate and supply electricity and hydrogen.

### BACKGROUND

With the world's energy consumption increasing everyday, the demand for electricity and fossil fuels continues to increase worldwide. To date, fossil fuels, such as coal and petroleum, are the primary fuels for fueling power plants and vehicles. With the amounts of fossil fuels being in limited supply, alternative fuels and sources of energy have gained attention worldwide.

The growing demand for electricity places a considerable strain on power grids worldwide resulting in numerous power outages. The high demand for electricity in peak periods causes power plants to operate at a higher capacity during these periods, as power plants typically do not operate at full capacity to allow for generators to be taken offline for repairs and maintenance. During peak periods, to keep up with demand, many power plants must utilize a greater percent of their generators, which can result in an inability to keep up with demand should one or more of the generators break down or require maintenance.

While electricity is produced from hydroelectric and nuclear power plants, these types of power plants are in limited supply and able to operate in limited locations, resulting in electricity typically being produced from generators fueled by fossil fuels. As a byproduct of the production of electricity, generators utilizing fossil fuels produce many pollutants, including greenhouse gases (CO and CO₂), which are emitted into the atmosphere. These greenhouse gases have been shown to result in the phenomenon known as global warming. The fossil fuels are also in limited supply, which will cause the cost of electricity to increase as the limited supply of fossil fuels is depleted.

To reduce pollution and conserve the limited amounts of fossil fuels available, alternative sources of energy are becoming more and more prevalent in today's society. One form of alternative energy is solar energy. By harnessing the power of the sun through solar cells, enormous amounts of solar energy may be collected and converted to electricity for consumer use. Solar energy is a clean source of power as solar energy is produced without the creation of pollutants, such as greenhouse gases (CO, CO₂), which adversely affect the environment. The production of solar energy also does not require the consumption of fossil fuels, which are limited in supply. Solar cells can be placed almost anywhere provided they have access to sunlight. Solar cells can also come in many different sizes depending upon the power requirement and/or space available making them suitable for residential use.

In addition to the demand for electricity, the worldwide demand for gasoline is steadily increasing as well. As third world countries are growing, so is their need for gasoline to power vehicles. The growing demand for gasoline coupled with the limited supply of petroleum has led to the introduction of alternative fuels such as hydrogen. Hydrogen can be produced from coal, natural gas and other hydrocarbons, or formed by the electrolysis of water. Moreover hydrogen can be produced without the use of fossil fuels, such as by the electrolysis of water using renewable energy, such as solar energy. Hydrogen has the highest density of energy per unit weight of any chemical fuel and is essentially non-polluting since the main by-product of burning hydrogen is water. Hydrogen can be used to power vehicles utilizing hydrogen powered internal combustion engines or fuel cells.

With energy consumption increasing worldwide and fossil fuels being in limited supply, there is a need for systems utilizing non-fossil fuel energy sources to produce electricity and alternative fuels allowing for independence from power grids and fossil fuels.

### SUMMARY OF THE INVENTION

The present invention discloses a power generation and supply system comprising one or more solar cells, a rechargeable battery, an electrolyzer, a hydrogen distribution system, and an electricity distribution system in electrical communication with the one or more solar cells and/or the rechargeable battery.

The one or more solar cells may comprise one or more triple junction amorphous silicon solar cells. The one or more solar cells may also comprise one or more roofing shingles including a solar cell active material deposited on a substrate. Electricity produced by the one or more solar cells is supplied to a battery for storage and/or the electricity distribution system for distribution to a power grid and/or one or more electrical devices. While various rechargeable batteries may be utilized, preferably, the rechargeable battery is a nickel metal hydride battery.

The electrolyzer receives electricity from the one or more solar cells and/or the rechargeable battery and produces hydrogen via the electrolytic decomposition of water. Hydrogen produced by the electrolyzer is then transfered to the hydrogen distribution system. The hydrogen distribution system receives the hydrogen produced from the electrolyzer and supplies the hydrogen to a hydrogen powered vehicle, a hydrogen consuming device, or a hydrogen storage vessel.

The hydrogen distribution system may comprise a hydrogen storage system in gaseous communication with the electrolyzer for receiving hydrogen produced by the electrolyzer and storing the received hydrogen in gaseous, liquid, or metal hydride form and a hydrogen dispenser for dispensing hydrogen from the hydrogen storage system to a hydrogen consuming device and/or a hydrogen storage vessel. The hydrogen storage system may comprise one or more pressure containment vessels at least partially filled with a hydrogen storage alloy.

The power generation and supply system according may further comprise a hydrogen fueled fuel cell in gaseous communication with the hydrogen distribution system and in electrical communication with the electricity distribution system and/or the rechargeable battery. The hydrogen fueled fuel cell receives hydrogen produced by the electrolyzer and produces electricity as needed to recharge the rechargeable battery and/or power one or more electrical devices. The hydrogen fueled fuel cell may be selected from alkaline fuel cells, PEM fuel cells, molten carbonate fuel cells, phosphoric acid fuel cells, and solid oxide fuel cells. The hydrogen fueled fuel cell may comprise one or more hydrogen electrodes including a hydrogen storage alloy providing for hydrogen storage capacity.

### BRIEF DESCRIPTION OF THE DRAWINGS

FIG. 1, is a depiction of an embodiment of the hydrogen delivery system in accordance with the present invention.

### DETAILED DESCRIPTION OF THE PREFERRED EMBODIMENTS OF THE INVENTION

Disclosed herein, is a power generation and supply system which collects solar energy and converts the solar energy to electricity, which may be used to power one or more electrical devices and/or stored for later use. The electricity generated by the system may also be supplied from the system to a power grid and/or used to produce hydrogen via the electrolytic decomposition of water into hydrogen and oxygen. The hydrogen produced via electrolysis may be stored and used to fuel a hydrogen consuming device or fill a hydrogen storage vessel. The hydrogen consuming device may be a vehicle, generator, or device powered by a fuel cell or and/or a hydrogen internal combustion engine, or any other hydrogen consuming apparatus.

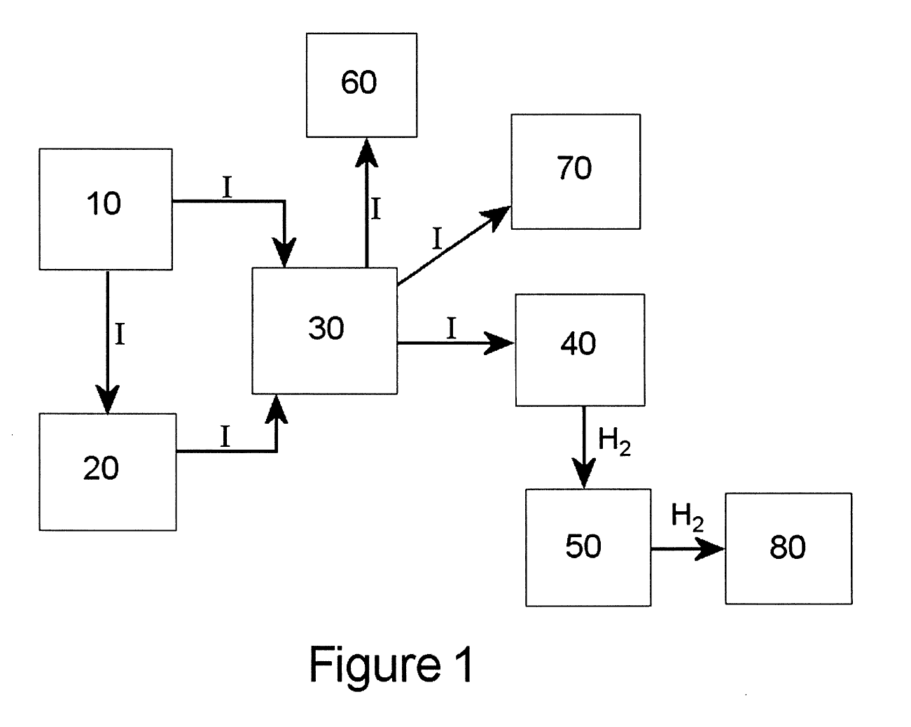

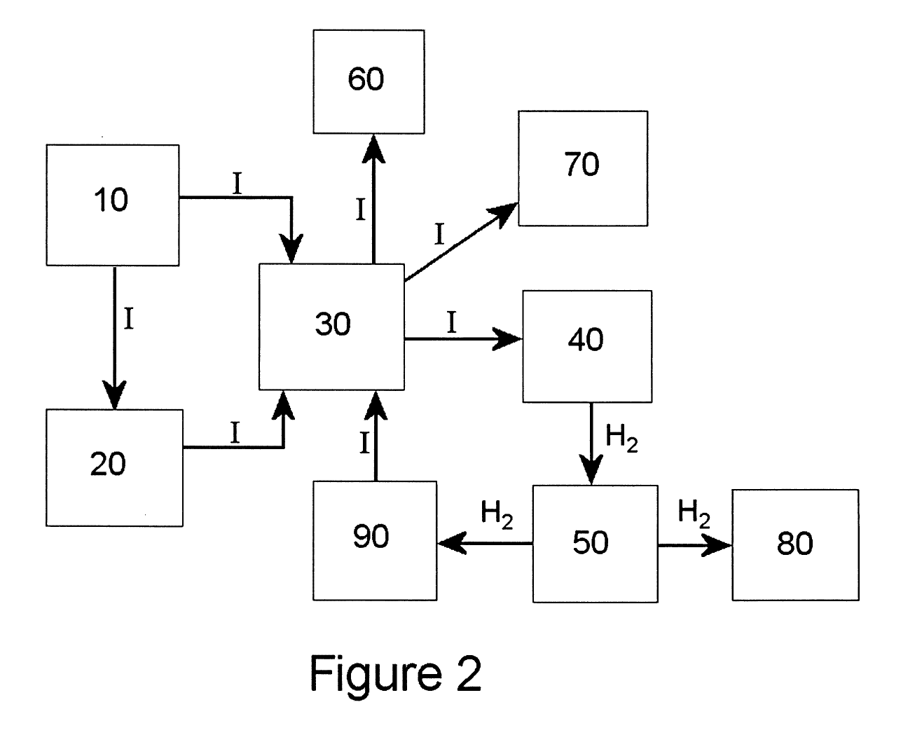

A schematic diagram of a first embodiment of the power generation and supply system is shown in FIG. 1. In FIG. 1, electrical current flows in the direction of the arrows and is designated as “I”, and hydrogen flows in the direction of the arrows and is designated as “H₂”. The power generation and supply system generally comprises one or more solar cells 10, a rechargeable battery 20, an electricity distribution system 30, an electrolyzer 40, and a hydrogen distribution system 50. The solar cells 10 convert sunlight into electricity which is stored in a rechargeable battery 20 or supplied to one or more electrical devices 60 or a power grid 70 via the electricity distribution system. Electricity stored in the rechargeable battery is supplied to the electricity distribution system 30 as needed to power one or more electrical devices 60. The electrolyzer 40 is supplied with electricity from the rechargeable battery 20 and/or the solar cells 10 via the electricity distribution system 30 and produces hydrogen via electrolysis. The hydrogen produced by the electrolyzer 40 may then be stored and/or distributed to a hydrogen consuming device 80 (such as a car or fuel cell) via a hydrogen distribution 50. A schematic diagram of a second embodiment of the power generation and supply system is shown in FIG. 2. In. FIG. 2, electrical current flows in the direction of the arrows and is designated as “I”, and hydrogen flows in the direction of the arrows and is designated as “H₂”. In the second embodiment, the power generation and supply system includes a fuel cell 90 fueled with hydrogen from the electrolyzer 40 for providing additional power as needed by utilizing hydrogen stored in the hydrogen distribution system 50.

The one or more solar cells 10 must be positioned such that they are able to collect sunlight. The one or more solar cells 10 may be located on the roof of a house, garage, or other building. The one or more solar cells may also be formed into shingles and incorporated into the roof of a house, garage, or another type of building.

The one or more solar cells 10 may be any solar cells generally known to one skilled in the art, however, the one or more solar cells preferably include an active material, such as a semiconductor material, deposited on a substrate. The substrate may be stainless steel, Kapton® (Registered Trademark of DuPont), or any other substrate materials well known in the art for the construction of solar cells.

The active material for the solar cells preferably has a n-i-p structure. The n-i-p structure consists of an i-type (intrinsic) semiconductor layer interposed between an n-type (negative charge carrier) semiconductor layer and a p-type (positive charge carrier) semiconductor layer. A transparent conducting electrode layer is contacted to the p-type layer and a metal electrode is contacted to the n-type layer. During operation, incident sunlight passes through the transparent electrode and p-type layer and is absorbed by the i-type layer. Absorption of sunlight by the i-type layer forms of electrons from the valence band to the conduction band and forms electron-hole pairs in the i-type layer. The electrons and electron-hole pairs are the charge carriers needed to produce electricity. The adjacent p-type and n-type layers establish a potential in the i-type layer that separates the electrons and holes. The electrons and holes are subsequently conducted to oppositely charged collection electrodes which provide an electrical current.

Representative semiconductor materials suitable for the absorption of solar energy include crystalline silicon, polycrystalline silicon, amorphous silicon, microcrystalline silicon or related materials, including alloys of silicon with germanium. Other materials such as GaAs, CdS and CuInSe2 may also be used. These materials can be prepared as n-type, i-type or p-type and have bandgap energies that permit absorption of at least a portion of the solar spectrum. Amorphous silicon is a preferred i-type material in a n-i-p structure because it possesses a direct bandgap and exhibits a high absorption strength over a wide wavelength range of the solar spectrum. The high absorbance of amorphous silicon is desirable because it provides for the efficient absorption of sunlight in thinner devices, which require less material.

A variety of n-i-p photovoltaic structures are available to maximizes the absorption of solar energy and the conversion efficiency of solar energy to electrical energy. Several strategies for improving the performance of amorphous silicon based photovoltaic devices include the use of microcrystalline silicon to form the p-type layer, integration of two or more n-i-p structures to form tandem devices, and inclusion of a back reflector layer in the structure. U.S. Pat. No. 4,609,771, the disclosure of which is herein incorporated by reference, discloses the use of microcrystalline silicon p-type layers in solar cells. The inventors therein demonstrate that microcrystalline silicon has a higher transparency to sunlight than amorphous silicon. As a result, use of a microcrystalline silicon p-type layer allows more incident sunlight to reach the i-type layer and a higher concentration of charge carriers is produced as a result. U.S. Pat. Nos. 4,600,801 and 5,977,476, the disclosures of which are herein incorporated by reference, also discuss microcrystalline and amorphous n-type and p-type silicon materials in photovoltaic devices.

The strategy associated with tandem devices is to couple multiple n-i-p structures in series in an attempt to collect as much incident sunlight as possible. Although high, the absorption efficiency of i-type amorphous silicon layers is substantially less than 100%. Placement of a second n-i-p structure directly below the n-i-p structure that is directly incident to the sunlight provides an opportunity to capture light not absorbed by the first n-i-p structure. Tandem structures including three adjacent n-i-p structures are commonly used and termed triple junction cells. Additional strategies such as bandgap tailoring of the i-layer from one n-i-p structure to the next have also been demonstrated to improve the light harvesting efficiency of tandem structures. In these strategies, separate n-i-p structures in a tandem structure include i-type layers that are optimized to selectively absorb different portions of the solar spectrum. Amorphous silicon, for example, may be used to absorb the short wavelength portions of the solar spectrum, while SiGe alloys having various amounts of Ge may be used to absorb longer wavelengths since alloying with Ge reduces the bandgap. Representative triple junction cell structures are described in the following journal publications, the disclosures of which are herein incorporated by reference: “Roll to roll manufacturing of amorphous silicon alloy solar cells with in situ cell performance diagnostics” by M. Izu and T. Ellison (Solar Energy Materials & Solar Cells vol. 78, p. 613-626 (2003)) and “Triple-junction amorphous silicon alloy solar cell with 14.6% initial and 13.0% stable conversion efficiencies” by J. Yang, A. Banerjee and S. Guha (Applied Physics Letters, vol. 70, p. 2975-2977 (1997)).

Back reflecting layers are reflective layers that are typically deposited directly on the substrate. The back reflecting layer reflects any light passing through all of the n-i-p cells stacked in a tandem device back through the stacked n-i-p devices for a second pass resulting in improved absorption efficiency. Representative back reflecting layer materials may include Al, ZnO, Ag, Ag/ZnO, and Al/ZnO.

An important advantage associated with amorphous silicon is the ability to manufacture it in a large scale continuous manufacturing process. Crystalline silicon, on the other hand, can only be prepared in a slow, smaller scale process because of the slow crystallization processes associated with its formation. Consequently, great efforts have been directed at the large scale production of amorphous silicon. Modern web rolling processes permit the high speed production of single and multilayer thin films amorphous silicon based devices. The production of amorphous silicon on a continuous web has been previously described in, for example, U.S. Pat. Nos. 4,485,125; 4,492,181; and 4,423,701, and U.S. application Ser. No. 10/228,542 the disclosures of which are herein incorporated by reference.

The rechargeable battery 20 may be any type of battery capable of receiving electricity, storing electricity, and supplying stored electricity on demand. Preferably the rechargeable battery 20 is a nickel metal hydride battery. Nickel metal hydride batteries generally comprise a negative electrode and a positive electrode in contact with an electrolyte.

The negative electrode in a nickel metal hydride battery generally comprises an active material supported on a substrate. The active material is generally comprised of a hydrogen storage alloy which provides for the reversible electrochemical storage of hydrogen. Upon application of an electrical potential across the NiMH battery, the negative electrode active material is charged by the electrochemical absorption of hydrogen and the electrochemical generation of hydroxyl ions. The electrochemical reaction occurring at the negative electrode is shown as: 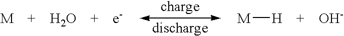
The reactions at the negative electrode are reversible. Upon discharge, the stored hydrogen is released to form a water molecule and release an electron.

The hydrogen storage material included in the active material of the negative electrode may be an AB, AB₂, A₂B₇, or AB₅ hydrogen storage alloy. The hydrogen storage material may be chosen from the Ti—V—Zr—Ni alloys such as those disclosed in U.S. Pat. No. 4,551,400 (“the '400 Patent”), the disclosure of which is incorporated by reference. The hydrogen storage alloys disclosed in the '400 Patent have a Ti—V—Ni composition, where at least Ti, V, and Ni are present with at least one or more of Cr, Zr, and Al. The materials of the '400 Patent are multiphase materials, which may contain, but are not limited to, one or more phases with C₁₄ and C₁₅ crystal structures.

There are other Ti—V—Zr—Ni alloys which may also be used for the hydrogen storage material of the negative electrode. Another family of materials are those described in U.S. Pat. No. 4,728,586 (“the '586 Patent”), the disclosure of which is incorporated by reference. The '586 Patent discloses Ti—V—Ni—Zr alloys comprising Ti, V, Zr, Ni, and a fifth component, Cr. The '586 Patent mentions the possibility of additives and modifiers beyond the Ti, V, Zr, Ni, and Cr components of the alloys, and discusses other additives and modifiers, the amounts and interactions of the modifiers, and the particular benefits expected from them.

The negative electrode may be a pasted electrode or may be a compacted electrode which are formed by either pasting or compressing the hydrogen storage material onto a porous metal substrate. Generally, a porous metal substrate includes, but is not limited to, mesh, grid, matte, foil, foam and plate. Preferably, the porous metal substrate used for the negative electrode is a mesh or grid. The porous metal substrate may be formed from one or more materials selected from copper, copper alloy, nickel coated with copper, nickel coated with copper alloy, and mixtures thereof. Preferably, the porous metal substrate is formed from copper or copper alloy.

Using a porous metal substrate including copper, has several important advantages. Copper is an excellent electrical conductor. Hence, its use can decrease the resistance of the negative electrode. By reducing the resistance of the negative electrode, the battery power wasted due to internal dissipation is lowered to provide a NiMH battery having increased output power. Copper also has excellent thermal conductivity, which aids in the temperature management of the nickel metal hydride batteries.

Copper is also a malleable metal. Malleability is very important because of the expansion and contraction of the negative electrodes during charge and discharge cycling of a NiMH battery. The increased malleability of the substrate helps prevent electrode breakage as a result of the expansion and contraction, thereby resulting in improved battery reliability. Increased substrate malleability also allows the substrate to more reliably hold the active hydrogen storage material that is compressed onto the substrate surface, which may improve battery reliability. Increased substrate malleability may also lessen the need to sinter the negative electrodes after the storage material is compressed onto the substrate surface. Eliminating the sintering process may result in reduce cost and an increase in the speed by which the electrodes are made.

Alkaline batteries present an extremely harsh operating environment for the electrodes. To protect the negative electrodes from the harsh environment within the battery, the porous metal substrate formed from the materials described above may be plated with a material that is electrically conductive yet resistant to corrosion in the battery environment. Examples of materials that can be used to plate the negative electrode include, but are not limited to, nickel and nickel alloy.

The positive electrode may be a sintered type electrode or a non-sintered type electrode, wherein non-sintered electrodes include pasted electrodes. Generally, a pasted positive electrode can be formed by pressing a powdered active positive electrode material into a porous metal substrate. NiMH batteries generally employ a positive electrode having nickel hydroxide as an active material. The reversible reaction occurring at the positive electrode is shown as:

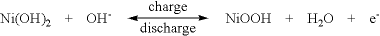

Examples of nickel hydroxide positive electrodes are described in U.S. Pat. Nos. 5,344,728 and 5,348,822 (which describe stabilized disordered positive electrode materials) and U.S. Pat. Nos. 5,569,563 and 5,567,549, the disclosures of which are hereby incorporated by reference.

The porous metal substrate of the positive electrode includes, but is not limited to, mesh, grid, matte, foil, foam and plate. The positive electrode may include a porous metal substrate that is formed from one or more materials selected from copper, copper alloy, nickel coated with copper, nickel coated with a copper alloy, and mixtures thereof. Forming the substrate from one or more of these materials increases the conductivity of the positive electrodes of the battery. By increasing the conductivity of the positive electrode, the amount of power wasted due to internal power dissipation may be lowered, which may increase the power output of the NiMH battery.

Due to the extremely harsh operating environment for the positive electrodes, the porous metal substrate formed from the materials described above may be plated with a material that is electrically conductive yet resistant to corrosion in the battery environment. Examples of materials that can be used to plate the negative electrode include, but are not limited to, nickel and nickel alloy.

The conductivity of the positive electrode may be increased by introducing lines of higher electrical conductivity into the porous metal substrate. These “current collection lines” are formed to have a higher electrical conductivity than the remainder of the substrate thus providing high conductivity pathways from points remote from the current collection tabs of the positive electrodes. The current collection lines may be formed in a porous metal substrate which includes, but is not limited to, mesh, grid, matte, foil, foam and plate as described above. Preferably, the porous metal substrate is formed from foam. More preferably, the porous metal substrate is formed from nickel foam or nickel plated copper foam.

The conductivity of the positive electrodes may be further enhanced by the addition of conductive additives added to the nickel hydroxide active electrode material. Conductive additives may be chosen from nickel particles, nickel fibers, graphite particles, nickel plated graphite particles, nickel plated copper particles, nickel plated copper fibers, nickel flakes, and nickel plated copper flakes.

In NiMH batteries, heating occurs during charging and discharging. During overcharge it is possible that heat generated by the recombination of oxygen, while not significant in small consumer batteries, could become problematic in the batteries of the system described herein, particularly when plastic cases and pasted electrodes are used.

Heat generated during overcharge can become trapped in the cell where temperatures can reach 80° C. In NiMH batteries, excessive heat may decrease performance and reduce cell life due to separator and seal degradation as well as accelerated degradation of the active materials.

Pasted metal hydride electrodes may be used to improve gas recombination rates while protecting the hydrogen storage alloy from oxidation and corrosion. Pasted metal hydride electrodes, however, have relatively low thermal conductivity. A pasted electrode may be made by mixing the active material powder with plastic binders, such as Teflon, and other nonconductive hydrophobic materials and affixing the mixture to the electrode.

The thermal management of the nickel metal hydride battery should provide adequate cooling to insure optimal performance and durability in a wide variety of operating conditions. Nickel-metal hydride batteries show charge efficiency performance degradation at high temperatures, such as over 43° C., due to problems resulting from oxygen evolution at the nickel positive electrode. To avoid these inefficiencies the battery temperature during charge should ideally be held below these temperatures. Nickel-metal hydride batteries also show power performance degradation at temperatures below about −1° C. due to degraded performance in the negative electrode. To avoid low power, the battery temperature should be held above about −1° C. during discharge.

The electrolyzer 40 generally comprises an electrolytic anode and an electrolytic cathode in contact with an electrolyte and a membrane used to separate the electrolytic anode, the electrolytic cathode, and the reaction products. During operation, a fixed current is applied across the electrolytic anode and the electrolytic cathode while the electrolytic anode and electrolytic cathode are in contact with the electrolyte. Electrochemical reactions taking place at the electrolytic anode and electrolytic cathode form oxygen and hydrogen gas, respectively. The reactions and the overall reaction are represented as:
Cathode: 2H₂O+2e⁻→H₂+2OH⁻
Anode: 2OH⁻→½O₂+2e⁻+H₂O
Overall: H₂O→H₂+½O₂

The particular materials used for the electrolytic anode and the electrolytic cathode are important since they provide the necessary catalysts for the reactions taking place at the anode and cathode. For example, the role the electrolytic anode catalyst M is believed to play in evolving oxygen in an electrolytic cell is as follows:
M+OH⁻→MOH+e⁻
MOH+OH−→MO+H₂O+e⁻
2MO→MO₂+M
MO₂→O2+M

In addition to allowing the desired reactions to take place, the catalytic efficiency of the catalytic materials is a very important consideration since an effective catalytic material reduces the operating energy requirements of the cell. The applied voltage necessary to produce the anode and cathode reactions in an electrolytic cell is the sum of the decomposition voltage (thermodynamic potential) of the compounds in the electrolyte being electrolyzed, the voltage required to overcome the resistance of the electrolyte and the electrical connectors of the cell, and the voltage required to overcome the resistance to the passage of current at the surface of the anode and cathode (charge transfer resistance). The charge transfer resistance is referred to as the overvoltage. The overvoltage represents an undesirable energy loss which adds to the operating costs of the electrolytic cell.

The electrolytic anode is generally comprises an electrolytic anode active material supported by a substrate. The electrolytic anode active material may be any material generally used for electrolytic anodes as known to those skilled in the art. The electrolytic anode material may formed from a host matrix including at least one transition metal element, preferably Co, Ni, or Mn, which is structurally modified by incorporating one or more modifier elements, one of which may be a transition metal element, to improve its catalytic properties. Modifier elements such as Co, Ni, Cr, Li, In, K, Sn, C, O, Mn, Ru, and Al structurally modify the local chemical environments of the host matrix to provide a material having an increased density of catalytically active sites. The material may also include one or more leachable elements, such as Li, Al, or Zn, which are subsequently at least partially leached out to leave a layer of a higher surface to volume ratio, which increases catalytic activity by further modifying the catalytic material. These types of electrolytic anodes are described in detail in U.S. Pat. No. 4,537,674 to Ovshinsky et al., the disclosure of which is hereby incorporated by reference.

The substrate at used in the electrolytic anode may be any of the conventional substrates such as sheet, expanded metal, wire or screen configurations. The substrates may be formed from nickel, steel, titanium, graphite, copper, or other suitable materials.

The electrolytic anode active material may be applied to the substrate by vacuum deposition of the components (sputtering, vapor deposition, plasma deposition) or by spraying. The thickness of the layer of electrolytic cathode active material is preferably on the order of 0.5 to 50 microns.

The electrolytic cathode is generally comprises an electrolytic cathode active material supported by a substrate. The electrolytic cathode active material may be any material generally used for electrolytic cathodes as known to those skilled in the art. The electrolytic cathode active material may be comprised of a host matrix including at least one transition element which is structurally modified by incorporating one or more modifier elements, at least one of which is a transition metal element to improve the catalytic properties of the electrode. Modifier elements, including for example Ti, Mo, Sr, Si, La, Ce, O, and Co, structurally modify the local chemical environment of the host matrix formed of a transition element such as Ni, Mo, or Co to provide a material having an increased density of catalytically active sites which exhibits low overvoltages. These types of electrolytic cathodes are described in detail in U.S. Pat. No. 4,545,883 to Ovshinsky et al., the disclosure of which is hereby incorporated by reference.

The substrate at used in the electrolytic cathode may be any of the conventional substrates such as sheet, expanded metal, wire or screen configurations. The substrates may be formed from nickel, steel, titanium, graphite, copper, or other suitable materials.

The electrolytic cathode active material may be applied to the substrate by vacuum deposition of the components (sputtering, vapor deposition, plasma deposition) or by spraying. The thickness of the layer of electrolytic cathode active material is preferably on the order of 0.5 to 2 microns or greater.

The hydrogen distribution system 50 generally comprises a hydrogen dispenser including a conduit through which hydrogen is transferred to a hydrogen consuming device or a hydrogen storage vessel which may or may not be coupled with a hydrogen consuming device. The hydrogen dispenser also includes a mating connector for coupling the conduit to the hydrogen consuming device or hydrogen storage vessel. The mating connector may be any adapter suitable for sealably connecting the conduit to the hydrogen consuming device or hydrogen storage vessel such that the hydrogen consuming device or hydrogen storage vessel is in gaseous communication with the hydrogen distribution system.

The hydrogen distribution system 50 may also include a hydrogen storage system for receiving and storing hydrogen produced by the electrolyzer. The hydrogen storage system generally includes one or more pressure containment vessels capable of storing hydrogen in gaseous, liquid, or metal hydride form. The pressure containment vessels may be constructed from aluminum, stainless steel, or other suitable materials. Preferably, the hydrogen storage system includes one or more pressure containment vessels at least partially filled with a hydrogen storage alloy which stores hydrogen in metal hydride form. Heat fins, heaters, cooling jackets, or heat exchanger tubing may be placed in thermal contact with the hydrogen storage alloy or the pressure containment vessel to aid in the transfer of heat to and from the hydrogen storage alloy during hydrogen absorption or desorption. The hydrogen storage alloy utilized in the one or more pressure containment vessels may be selected from AB, AB₂ and AB₅ alloys, such as rare earth-nickel alloys, titanium-manganese alloys, titanium-zirconium alloys, titanium-iron alloys, magnesium alloys, and the like. Examples of such alloys can be found in U.S. Pat. Nos. 6,726,783; 6,591,616; 6,536,487; 6,517,970; 6,491,866; 6,328,821; 6,193,929; 6,103,024; 5,976,276; 5,916,381; 5,840,440; 4,832,913; 4,431,561.

The electricity distribution system 30 generally includes one or more cables in electrical communication with a power grid through which electricity is supplied to the power grid from the one or more solar cells and/or the rechargeable battery. The electricity distribution system may also include a controller for controlling the amount of electricity supplied to the power grid. The electricity distribution system may also include a metering system for measuring the amount of electricity supplied to the power grid.

The fuel cell 90 may be any type of hydrogen fueled fuel cell currently available and known to those skilled in the art. Such fuel cells may include alkaline fuel cells, PEM fuel cells, molten carbonate fuel cells, phosphoric acid fuel cells, and solid oxide fuel cells. Preferably, the hydrogen fueled fuel cell is a PEM fuel cell or an alkaline fuel cell. When additional electricity is needed, hydrogen is supplied to the fuel cell from the electrolyzer and/or the hydrogen distribution system. The fuel cell receives the hydrogen and produces an electrical current which may be utilized to power one or more electrical devices and/or used to recharge the rechargeable battery.

An alkaline fuel cell is generally comprised of a hydrogen electrode and an oxygen electrode in contact with an alkaline electrolyte. Each hydrogen electrode has an electrolyte interface and a hydrogen interface and each oxygen electrode has an electrolyte interface and an oxygen interface. The electrolyte interfaces of the hydrogen electrode and the oxygen electrode are in contact with and separated by an electrolyte contained in an electrolyte chamber formed between the electrolyte interfaces of the hydrogen and oxygen electrodes.

In an alkaline fuel cell, the reaction at the hydrogen electrode occurs between hydrogen fuel and hydroxyl ions (OH⁻) present in the electrolyte, which react to form water and release electrons:
H₂+2OH⁻→2H₂O+2e⁻.
At the oxygen electrode, oxygen, water, and electrons react in the presence of the oxygen electrode catalyst to reduce the oxygen and form hydroxyl ions (OH⁻):
O₂+2H₂O+4e⁻→4OH⁻.
The flow of electrons is utilized to provide electrical energy for a load externally connected to the hydrogen and oxygen electrodes.

The catalyst in the hydrogen electrode of the alkaline fuel cell has to not only split molecular hydrogen to atomic hydrogen, but also oxidize the atomic hydrogen to release electrons. The overall reaction can be seen as (where M is the catalyst):
M+H₂→2MH→M+2H⁺+2e⁻.
Thus the hydrogen electrode catalyst must efficiently dissociate molecular hydrogen into atomic hydrogen.

The hydrogen electrode for the alkaline fuel cell is generally comprised of an anode active material deposited on a substrate. The anode active material may be any of those commonly used for fuel cell hydrogen electrodes. Preferably, the anode active material comprises one or more non-noble metal based catalysts. Most preferably, the anode active material comprises one or more hydrogen storage alloys providing for hydrogen storage capacity. Hydrogen electrodes including a hydrogen storage alloy are disclosed in detail in U.S. Pat. No. 6,447,942 to Ovshinsky et al., the disclosure of which is hereby incorporated by reference. The substrate may be any of the conventional substrates such as sheet, expanded metal, wire or screen configurations. The substrates may be formed from nickel, steel, titanium, graphite, copper, or other suitable materials.

The oxygen electrode for the alkaline fuel cell is generally comprised of a cathode active material deposited on a substrate. The cathode active material may be any of those commonly used for fuel cell oxygen electrodes. Preferably, the cathode active material comprises one or more non-noble metal based catalysts. Most preferably, the cathode active material comprises one or more redox couples which provide for oxygen storage capacity. Oxygen electrodes utilizing redox couples for oxygen storage capacity are disclosed in detail in U.S. Pat. No. 6,620,539 to Ovshinsky et al., the disclosure of which is hereby incorporated by reference. The substrate may be any of the conventional substrates such as sheet, expanded metal, wire or screen configurations. The substrates may be formed from nickel, steel, titanium, graphite, copper, or other suitable materials.

A PEM fuel cell is generally comprised of a hydrogen electrode and an oxygen electrode. Each hydrogen electrode has an electrolyte interface and a hydrogen interface and each oxygen electrode has an electrolyte interface and an oxygen interface. The electrolyte interfaces of the hydrogen electrode and the oxygen electrode are in contact with and separated by a proton exchange membrane formed from a solid acidic electrolyte. The proton exchange membrane may comprise materials such as Nafion® (registered trademark of DuPont)and modified polysulfonic acid. The proton exchange membrane allows hydrogen atoms to flow through it, while preventing the flow of electrons therethrough. Where more than one hydrogen electrode and oxygen electrode is utilized, the PEM fuel cell may further comprise one or more bipolar plates which provide electrical communication between the electrodes. The one or more bipolar plates are disposed between each hydrogen electrode/oxygen electrode pair adjacent to the hydrogen interface of the hydrogen electrodes and the oxygen interface of the oxygen electrode. The bipolar plates may have a series of flow channels which provide pathways for the hydrogen and/or oxygen to contact the respective electrodes and aid in distribution of hydrogen and/or oxygen across the respective interfaces of the electrodes. Bipolar plates may also be shared between electrodes thereby reducing the number of bipolar plates in the PEM fuel cell. End plates are disposed at the ends of each PEM fuel cell to maintain the structural integrity of the fuel cell.

The hydrogen electrode for the PEM fuel cell is generally comprised of an anode active material deposited on a substrate. The anode active material may be any of those commonly used for PEM fuel cell hydrogen electrodes. Preferably the anode active material comprises non-noble metal based catalysts. Most preferably, the anode active material comprises one or more hydrogen storage alloys providing for hydrogen storage capacity. The substrate may be any of the conventional substrates such as sheet, expanded metal, wire or screen configurations. The substrates may be formed from nickel, steel, titanium, graphite, copper, or other suitable materials.

The oxygen electrode for the PEM fuel cell is generally comprised of a cathode active material deposited on a substrate. The cathode active material may be any of those commonly used for PEM fuel cell oxygen electrodes. Preferably the cathode active material includes one or more non-noble metal based catalysts. Examples of non-noble metal catalysts that may be used in the PEM oxygen electrode are metal carbides including at least one transition metal element, pyrolized macrocyclics modified with one or more transition metal oxides, transition metal oxides. and titanium oxide based materials. The substrate may be any of the conventional substrates such as sheet, expanded metal, wire or screen configurations. The substrates may be formed from nickel, steel, titanium, graphite, copper, or other suitable materials.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A power generation and supply system comprising:
one or more solar cells for producing an electrical current;
a rechargeable battery in electrical communication with said one or more solar cells for storing said electrical current produced by said one or more solar cells;
an electrolyzer for producing a stream of gaseous hydrogen, said electrolyzer being supplied with said electrical current from said one or more solar cells and/or said rechargeable battery;
a hydrogen distribution system for receiving said stream of gaseous hydrogen produced by said electrolyzer and supplying said hydrogen to a hydrogen powered vehicle, a hydrogen consuming device, or a hydrogen storage vessel; and
an electricity distribution system in electrical communication with said one or more solar cells and said rechargeable battery for supplying said electrical current to a power grid and/or one or more electrical devices.

2. The power generation and supply system according to claim 1, wherein said one or more solar cells comprise one or more triple junction amorphous silicon solar cells.

3. The power generation and supply system according to claim 1, wherein said one or more solar cells comprise one or more roofing shingles including a solar cell active material deposited on a substrate.

4. The power generation and supply system according to claim 3, wherein said one or more solar cells comprise one or more triple junction amorphous silicon solar cells.

5. The power generation and supply system according to claim 1, wherein said rechargeable battery is a nickel metal hydride battery.

6. The power generation and supply system according to claim 1, wherein said hydrogen distribution system comprises:
a hydrogen storage system in gaseous communication with said electrolyzer for receiving said stream of gaseous hydrogen produced by said electrolyzer and storing said stream of gaseous hydrogen in gaseous, liquid, or metal hydride form; and
a hydrogen dispenser for dispensing the stored hydrogen from said hydrogen storage system to a hydrogen consuming device and/or a hydrogen storage vessel.

7. The power generation and supply system according to claim 6, wherein said hydrogen storage system comprises one or more pressure containment vessels at least partially filled with a hydrogen storage alloy.

8. The power generation and supply system according to claim 1 further comprising a hydrogen fueled fuel cell in gaseous communication with said hydrogen distribution system and in electrical communication with said electricity distribution system.

9. The power generation and supply system according to claim 8, wherein said hydrogen fueled fuel cell comprises one or more hydrogen electrodes including a hydrogen storage alloy providing for hydrogen storage capacity.

10. The power generation and supply system according to claim 8, wherein said hydrogen fueled fuel cell is selected from alkaline fuel cells, PEM fuel cells, molten carbonate fuel cells, phosphoric acid fuel cells, and solid oxide fuel cells.
